(19) United States
(12) Patent Application Publication
(10) Pub. No.: US 2012/0211943 A1
(43) Pub. Date: Aug. 23, 2012

(54) SEALING DEVICE AND METHOD FOR PROVIDING A SEAL IN A TURBINE SYSTEM

(75) Inventors: Rebecca Evelyn Hefner, Simpsonville, SC (US); Canan Uslu Hardwicke, Simpsonville, SC (US); Victor John Morgan, Greenville, SC (US)

(73) Assignee: GENERAL ELECTRIC COMPANY, Schenectady, NY (US)

(21) Appl. No.: 13/031,816

(22) Filed: Feb. 22, 2011

(51) Int. Cl. F16J 15/06

(52) U.S. Cl. 277/316; 277/651

(57) ABSTRACT

A sealing device and a method for providing a seal between adjacent components in a turbine system are disclosed. The sealing device includes a seal plate configured to provide a seal between adjacent components, a wire mesh mounted to the seal plate, the wire mesh defining a plurality of voids, and a sealant impregnating the wire mesh such that at least a portion of the plurality of voids include the sealant therein.

### FIELD OF THE INVENTION

The present disclosure relates in general to a turbine system, and more particularly to sealing devices and methods for providing seals between adjacent components of a turbine system.

### BACKGROUND OF THE INVENTION

Turbine systems are widely utilized in fields such as power generation. A conventional gas turbine system, for example, includes a compressor, a combustor, and a turbine. During operation of a turbine system, various components in the system are subjected to high temperature flows. Many of the components are disposed in annular arrays about an axis of the gas turbine system. Further, many of the components are positioned adjacent to other components, in annular arrays, radially, axially, or otherwise. For example, compressor and turbine blades, nozzles, and shroud blocks are positioned in annular arrays and are further positioned adjacent to each other. Frequently, gaps exist between adjacent components. These gaps may allow for leakage of the high temperature flows from the hot gas path, resulting in decreased performance, efficiency, and power output of the turbine system.

Further, since higher temperature flows generally result in increased performance, efficiency, and power output of the turbine system, the components of the system must be cooled to allow the turbine system to operate at increased temperatures. Various strategies are known in the art for cooling various components. For example, a cooling medium may be routed to the components. However, the gaps between adjacent components may allow for leakage of the cooling medium and mixing with the high temperature flows, resulting in further decreased performance, efficiency, and power output of the turbine system.

Various strategies are known in the art to reduce turbine system losses due to leakage and mixing. For example, sealing mechanisms, such as leaf seals, spring seals, and pins, have been utilized to seal the gaps between various adjacent components. However, these sealing mechanisms, while preventing some leakage, may not adequately seal the gaps between adjacent components.

Thus, an improved sealing device and an improved method for providing a seal between adjacent components in a turbine system are desired in the art.

### BRIEF DESCRIPTION OF THE INVENTION

Aspects and advantages of the invention will be set forth in part in the following description, or may be obvious from the description, or may be learned through practice of the invention.

In one embodiment, a sealing device for providing a seal between adjacent components is disclosed. The sealing device includes a seal plate configured to provide a seal between adjacent components, a wire mesh mounted to the seal plate, the wire mesh defining a plurality of voids, and a sealant impregnating the wire mesh such that at least a portion of the plurality of voids include the sealant therein.

In another embodiment, a method for providing a seal between adjacent components is disclosed. The method includes mounting a wire mesh to a seal plate, the seal plate configured to provide a seal between the adjacent components, the wire mesh defining a plurality of voids, and impregnating the wire mesh with a sealant such that at least a portion of the plurality of voids include the sealant therein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of a gas turbine system according to one embodiment of the present disclosure;

FIG. 2 is a sectional side view of the turbine section of a gas turbine system including a plurality of sealing devices according to one embodiment of the present disclosure;

FIG. 3 is a perspective view of a sealing device sealing a gap between adjacent components according to one embodiment of the present disclosure;

FIG. 4 is a top view of a sealing device according to one embodiment of the present disclosure; and

FIG. 5 is a cross-sectional view of a sealing device, along the lines 5-5 of FIG. 4, according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

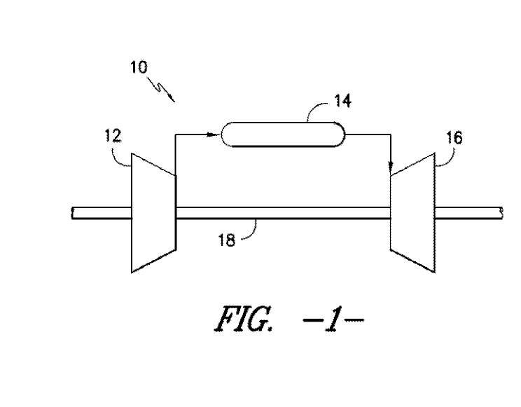

FIG. 1 is a schematic diagram of a gas turbine system 10. The system 10 may include a compressor 12, a combustor 14, and a turbine 16. Further, the system 10 may include a plurality of compressors 12, combustors 14, and turbines 16. The compressor 12 and turbine 16 may be coupled by a shaft 18. The shaft 18 may be a single shaft or a plurality of shaft segments coupled together to form a shaft 18.

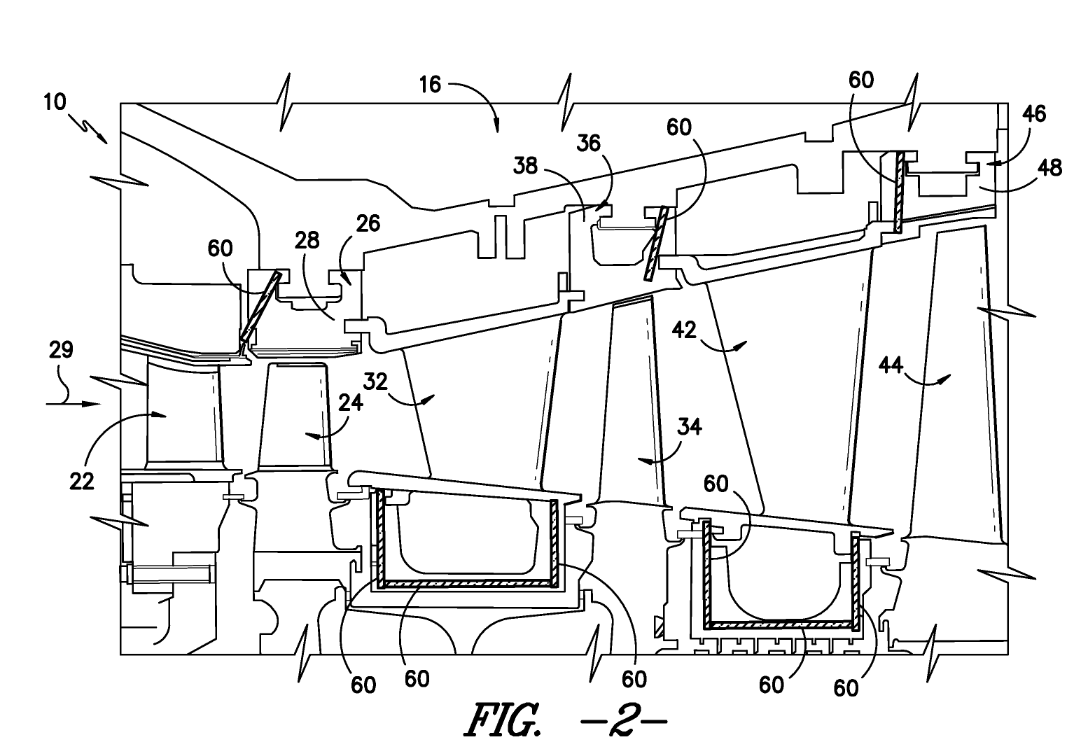

The compressor 12 and the turbine 16 may each include a plurality of stages. For example, one embodiment of a turbine 16 including three stages is shown in FIG. 2. For example, a first stage of the turbine 16 may include an annular array of nozzles 22 and an annular array of buckets 24. The nozzles 22 may be disposed and fixed circumferentially about the shaft 18. The buckets 24 may be disposed circumferentially about the shaft 18 and coupled to the shaft 18. A shroud 26, formed by an annular array of shroud blocks 28, may surround the buckets 24 and be connected to the nozzles 22 to partially define hot gas path 29. A second stage of the turbine 16 may be disposed downstream of the first stage and include similarly disposed nozzles 32, buckets 34, and shroud 36 formed by shroud blocks 28 and partially defining hot gas path 29. A third stage of the turbine 16 may be disposed downstream of the second stage and may include similarly disposed nozzles 42, buckets 44, and shroud 46 formed by shroud blocks 48 and partially defining hot gas path 29. It should be understood that neither the turbine 16 nor the compressor 12 is limited to three stages, but rather that any suitable number of stages is within the scope and spirit of the present disclosure. Further, it should be understood that the various components of the turbine 16 need not be arranged as described above, and rather that any suitable arrangement of components in a turbine 16, compressor 12, or system 10 in general is within the scope and spirit of the present disclosure.

Various adjacent components of the turbine 16 as shown in FIG. 2, various adjacent components of the compressor 12, such as buckets, nozzles, and shroud components, and/or various adjacent components of the system 10 in general, may define gaps 50 therebetween. These gaps may allow for the leakage of hot gas or cooling fluid therethrough, thus reducing the efficiency and output of the system 10.

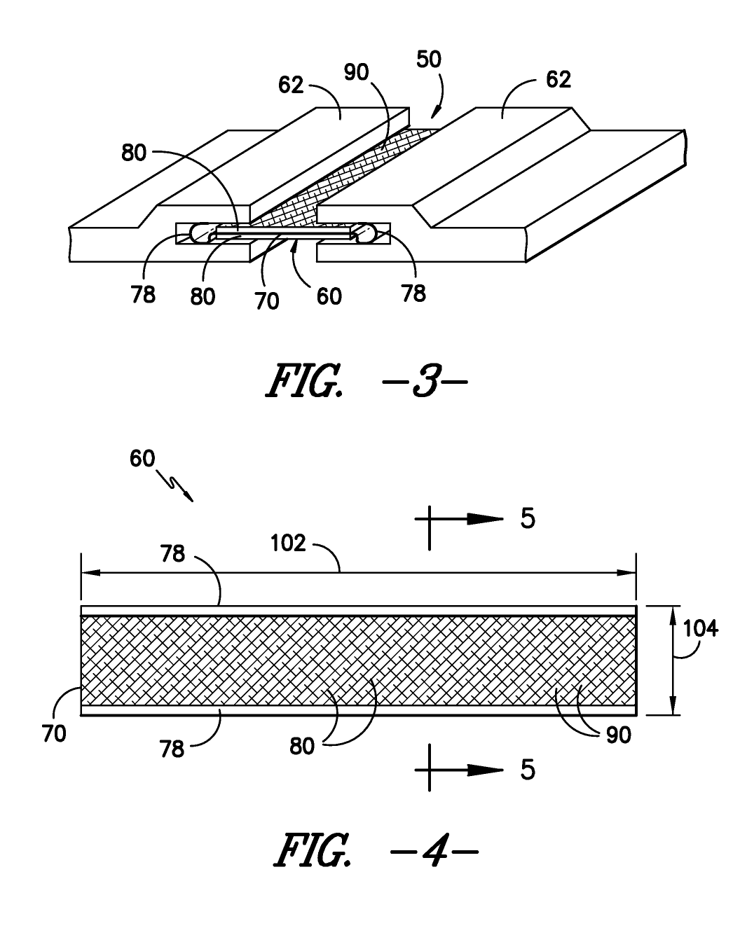

Thus, an improved sealing device 60 is disclosed for providing a seal between adjacent components, such as adjacent components of a turbine system 10. In exemplary embodiments, the adjacent components may be any components at least partially exposed to a high temperature flow of gas through the system 10. For example, a component, designated in FIG. 3 as component 62, may be a bucket, nozzle, shroud, transition piece, retaining rings, compressor exhaust, or any components thereof, as described above or otherwise. However, it should be understood that the present disclosure is not limited to any above disclosed components, and rather that any suitable adjacent components defining gaps 50 therebetween are within the scope and spirit of the present disclosure.

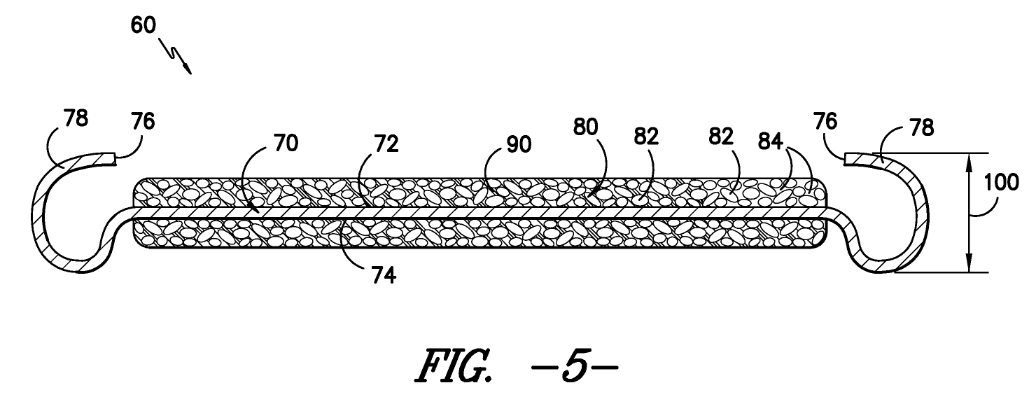

As shown in FIGS. 3 through 5, the sealing device 60 of the present disclosure may comprise various components configured to provide improved sealing in gaps 50 between adjacent components 62 of a system 10. For example, the sealing device 60 may include a seal plate 70. The seal plate 70 may be configured to provide a seal between adjacent components 62 of the turbine system 10. The seal plate 70 may have any shape and size suitable to fit in a gap 50. In exemplary embodiments, for example, the seal plate 70 may include a first outer surface 72, an opposed second outer surface 74, and an edge surface 76 therebetween. The edge surface 76 may at least partially define the periphery of the seal plate 70.

The seal plate 70 may in general be formed from any suitable material. For example, the seal plate 70 may be formed from a metal or metal alloy. In exemplary embodiments, the seal plate 70 may be formed from a steel alloy, such as a high temperature steel alloy. Alternatively, the seal plate 70 may be formed from any suitable material, such as a ceramic or other suitable non-metal.

As discussed above, the seal plate 70 may be configured to provide a seal between adjacent components 62. For example, the seal plate 70 may be sized and shaped to cover at least a portion of a gap 50 between adjacent components 62, thus at least partially blocking the leakage of flows through the gap 50. Additionally or alternatively, the seal plate 70 may include a load member 78 or a plurality of load members 78. The load member 78 may be configured to contact one or more of the adjacent components 62 to provide the seal. For example, FIG. 3 illustrates the load members 78 directly contacting various surfaces of the adjacent components 62, with the seal plate 70 extending through the gap 50 between the adjacent components 62. A load member 78 may contact one or more surfaces of one or more adjacent components 62. This may allow the load members 78 to position the seal plate 70 in the gap 50 to provide sealing of the gap 50.

Further, as discussed below, in some embodiments, load members 78 may be configured to prevent other elements of the sealing device 60, such as wire meshes and sealants, from contacting the adjacent components 62. Alternatively, however, the other elements may be mounted on the seal plate 70 such that portions of the elements coat the load members 78. In these embodiments, the load members 78 may indirectly contact the adjacent components 62, with portions of the various elements disposed between the load members 78 and the various surfaces of the adjacent components 62.

A load member 78 may, in some embodiments, further be resilient, and thus have spring-like characteristics that provide sealing between the adjacent components 62. For example, a seal plate 70 including a load member 78 or a plurality of load members 78 may be placed in a gap 50 with the load members 78 compressed against a surface or surfaces of a component 62. The resilient force of the load members 78 acting counter to the compressive force on the load members 78 may force the seal plate 70 in the gap 50 against the adjacent components 62, thus further sealing the gap 50.

The load members 78 may, in exemplary embodiments, be integral with the remainder of the seal plate 70. For example, the load members 78 may be portions of the seal plate 70, such as side portions adjacent to or including a portion of the edge surface 76, that are bent or deformed. In exemplary embodiments, as shown, the members 78 may have hook-like shapes. In alternative embodiments, the members 78 may not be integral with the remainder of the seal plate 70, and may instead be additionally added components mounted to the seal plate 70.

A load member 78 may be formed or mounted along a portion of the length of the seal plate 70 or the entire length of the seal plate 70, and/or or a portion of the width of the seal plate 70 or the entire seal plate 70. Alternatively, a load member 78 may be disposed along the entire periphery of the seal plate 70, or may be formed or mounted in any suitable location on the seal plate 70. In exemplary embodiments, as shown in FIGS. 3 through 5, the seal plate 70 may include two load members 78 disposed on opposing sides of the seal plate 70 and extending throughout the length of the seal plate 70.

The sealing device 60 of the present disclosure may further include a wire mesh 80, or a plurality of wire meshes 80. Wire mesh 80 may generally provide wear resistance to the sealing device 60, protecting and reducing wearing of the seal plate 70.

A wire mesh 80 may include and be formed from a plurality of woven or non-woven strands 82, and may thus define a plurality of voids 84 (see cutaway portion of FIG. 5) between the various strands 82. The strands 82 may be, for example, metallic strands, non-metallic strands, or a combination of metallic and non-metallic strands. For example, the wire mesh 80 may include a steel alloy, such as a high temperature steel alloy. Further, the wire mesh 80 may include any suitable non-metallic material or materials.

Wire mesh 80 may be mounted to the seal plate 70. For example, a wire mesh 80 may be mounted by welding, brazing, or any other suitable mounted process or apparatus. Further, wire mesh 80 may be mounted to any suitable surface or surfaces of the seal plate 70. For example, in some embodiments, a wire mesh 80 may be mounted to first outer surface 72, second outer surface 74, and/or edge surface 76. Wire mesh 80 mounted to the various surfaces may be a singular wire mesh 80 or a plurality of separate wire meshes 80, which may have similar or different strand compositions.

The sealing device 60 of the present disclosure may further include a sealant 90. The sealant 90 may be applied to the wire mesh 80 such that the sealant impregnates the wire mesh 80. Impregnating of the wire mesh 80, according to the present disclosure, means generally filling at least a portion of the voids 84 defined by the wire mesh 80. Thus, after the sealant 90 is applied to the wire mesh 80, the sealant 90 may impregnate the wire mesh 80 such that at least a portion of the plurality of voids 84, or substantially all of the plurality of voids 84, comprise the sealant 90 therein.

The sealant 90 may be impregnated into the wire mesh 80 using any suitable processes or apparatus. For example, impregnation may occur through vacuum sealing, pressure impregnation, vacuum drawing, or any other suitable impregnation process. Vacuum sealing may involve, for example, applying the sealant 90 to the wire mesh 80, sealing the wire mesh 80 and sealant 90 in a sealed environment, and utilizing a vacuum apparatus in the sealed environment to impregnate the wire mesh 80 with the sealant 90. Pressure impregnation may involve, for example, applying the sealant 90 to the wire mesh 80, and then applying pressure to the sealant 90 to impregnate the wire mesh 80 with the sealant 90, such as with a roller or other suitable device. Vacuum drawing may involve, for example, sealing the wire mesh 80 and sealant 90 in a sealed environment, and utilizing a vacuum apparatus in the sealed environment to draw the sealant 90 on and into the wire mesh 80, impregnating the wire mesh 80.

The sealant 90 may thus further provide a seal between the adjacent components 62 by preventing leakage around the seal plate 70. For example, leakage that escapes around the seal plate 70 may advantageously be inhibited from flowing through the voids 84 in wire mesh 80 and escaping through the gap 50 because of the impregnation of the voids 84 with the sealant 90.

In exemplary embodiments, the sealant 90 may be a high temperature sealant 90. Further, in some embodiments, the sealant 90 may include a clay, such as kaolinite or any other suitable clay. For example, in one exemplary embodiment, the sealant 90 may include kaolinite, epoxy novolak resin, aluminum powder or aluminum-containing powder, and calcium carbonate. In another exemplary embodiment, the sealant 90 may include kaolinite, sodium acrylate, and quartz. However, it should be understood that the present disclosure is not limited to the above disclosed compositions, and rather that any suitable sealant 90 composition is within the scope and spirit of the present disclosure.

As discussed, above, load members 78 may be configured to prevent the wire mesh 80 and sealant 90 from contacting the adjacent components 62. Thus, the load members 78 may extend beyond the wire mesh 80 and the sealant 90. For example, the sealing device 60 may define a thickness 100. The thickness 100 may, in some embodiments, be in the range between approximately 0.1 inches and approximately 1.5 inches. Thickness 100 may be defined at the thickest portion of the sealing device 60, which may in some embodiments be at a load member 78 or load members 78. Thus, in embodiments wherein the load members 78 are configured to prevent the wire mesh 80 and sealant 90 from contacting the adjacent components 62, the thickness 100 of the remainder of the sealing device 60 aside from the load members 78 may be less than the thickness 100.

The sealing device 100 may additionally define a length 102 and a width 104. The length 102 may, in some embodiments, be in the range between approximately 0.5 inches and approximately 16 inches. The width 104 may, in some embodiments, be in the range between approximately 0.5 inches and approximately 1.5 inches.

It should be understood, however, that the present disclosure is not limited to the above disclosed ranges of thicknesses, lengths, and widths, and rather that any suitable thicknesses, lengths, and/or widths are within the scope and spirit of the present disclosure.

The present disclosure is further directed to a method for providing a seal between adjacent components 62, such as adjacent components 62 of a turbine system 10. The method may include, for example, mounting a wire mesh 80 to a seal plate 70, as disclosed above. The method may further include, for example, impregnating the wire mesh 80 with a sealant 90 such that at least a portion of the plurality of voids 84 comprise the sealant 90 therein, as discussed above.

Further, the method may include inserting the sealing device 60, such as the seal plate 70, the wire mesh 80, and the sealant 90, into a gap 50 defined between the adjacent components 62.

Further, the method may include curing the sealant 90. In some exemplary embodiments, the sealant 90 may be cured before the sealing device 60 is inserted into a gap 50. Alternatively, the sealant 90 may be cured after being inserted in the gap 50. The sealant 90 may be, for example, sintered, fired, air-cured, temperature-cured, moisture-cured, or otherwise suitably cured. When the sealant 90 is cured after being inserted in the gap 50, curing may be completed independently of operation of the system 10, or may be completed during and due to operation of the system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A sealing device for providing a seal between adjacent components, the sealing device comprising:
a seal plate configured to provide a seal between adjacent components;
a wire mesh mounted to the seal plate, the wire mesh defining a plurality of voids; and
a sealant impregnating the wire mesh such that at least a portion of the plurality of voids comprise the sealant therein.

2. The sealing device of claim 1, wherein substantially all of the plurality of voids comprise the sealant therein.

3. The sealing device of claim 1, wherein the seal plate comprises a load member configured to contact at least one of the adjacent components to provide the seal.

4. The sealing device of claim 3, wherein the load member is configured to prevent the wire mesh and the sealant from contacting the adjacent components.

5. The sealing device of claim 3, wherein the seal plate comprises a plurality of load members.

6. The sealing device of claim 5, wherein the plurality of load members are integral portions of the seal plate.

7. The sealing device of claim 1, wherein the wire mesh comprises a plurality of metallic strands.

8. The sealing device of claim 7, wherein the wire mesh further comprises a plurality of non-metallic strands.

9. The sealing device of claim 1, wherein the sealant comprises a clay.

10. The sealing device of claim 1, wherein the sealant comprises kaolinite.

11. The sealing device of claim 1, wherein the seal plate comprises a metal or metal alloy.

12. The sealing device of claim 1, wherein the seal plate comprises a steel alloy.

13. A turbine system, comprising:
at least two adjacent components, the adjacent components defining a gap therebetween; and
a sealing device disposed in the gap, the sealing device comprising:
a seal plate configured to provide a seal between adjacent components of the turbine system;
a wire mesh mounted to the seal plate, the wire mesh defining a plurality of voids; and
a sealant impregnating the wire mesh such that at least a portion of the plurality of voids comprise the sealant therein.

14. A method for providing a seal between adjacent components, the method comprising:
mounting a wire mesh to a seal plate, the seal plate configured to provide a seal between the adjacent components, the wire mesh defining a plurality of voids; and,
impregnating the wire mesh with a sealant such that at least a portion of the plurality of voids comprise the sealant therein.

15. The method of claim 14, further comprising inserting the seal plate, the wire mesh, and the sealant into a gap defined between the adjacent components.

16. The method of claim 14, further comprising impregnating the wire mesh with the sealant such that substantially all of the plurality of voids comprise the sealant therein.

17. The method of claim 14, wherein the impregnating step comprises one of vacuum sealing, pressure impregnation, or vacuum drawing.

18. The method of claim 14, further comprising curing the sealant.

19. The method of claim 14, wherein the putty comprises a clay.

20. The method of claim 14, wherein the seal plate comprises a load member configured to contact at least one of the adjacent components to provide the seal.
